(19) United States
(12) Patent Application Publication
(10) Pub. No.: US 2022/0234308 A1
(43) Pub. Date: Jul. 28, 2022

(54) FIBER REINFORCED PROFILED OBJECT

(71) Applicant: SABIC GLOBAL TECHNOLOGIES B.V., BERGEN OP ZOOM (NL)

(72) Inventors: Jose SALES-FERNANDEZ, Geleen (NL); Qin YUAN, Geleen (NL); Christianus Johannes Jacobus MAAS, Geleen (NL); Rahul VALECHA, Geleen (NL); Rodrigo SANDOVAL RIVERA, Geleen (NL)

(21) Appl. No.: 17/617,078

(22) PCT Filed: Jun. 18, 2020
(86) PCT No.: PCT/EP2020/067039

§ 371 Date: Dec. 7, 2021

(30) Foreign Application Priority Data
Jun. 21, 2019 (EP) 19181682.6

(51) Int. Cl. B29C 70/20; B29D 99/00

(52) U.S. Cl. CPC B29C 70/202; B29K 2309/08; B29D 99/0003

(57) ABSTRACT

The invention relates to an elongate profiled object having a cross section, the object comprising a peripheral wall, forming a hollow profile extending in a longitudinal direction, wherein at least part of the peripheral wall is provided with a reinforcement layer extending in at least the longitudinal direction of the elongate profiled object,
wherein the reinforcement layer comprises a tape or a laminate of tapes,
wherein the reinforcement layer has a thickness of at least 0.6 mm and the tape is made of a first thermoplastic composition, which is a fiber reinforced thermoplastic composition comprising a flame retardant,
wherein the elongate profiled object is made of a second thermoplastic composition.

The present invention relates to a fiber reinforced profiled object, in particular a plank or board, specifically used for scaffolds. Furthermore, the invention relates to a method for making such a fiber reinforced elongate profiled object.

In the building industry, scaffolds, also called scaffolding or staging, are widely used to as a temporary structure to support a work crew and materials to aid in the construction, maintenance and repair of buildings, bridges and other (man-made) structures. In adapted form, scaffolds can be used for formwork and shoring, grandstand seating, concert stages and the like. Several types of scaffolds used worldwide nowadays. The most used and versatile type is the type using Tube and Coupler components, made of steel tubes connected with steel clamps (although aluminum may be used as well). Timber scaffolds are used as well, but have less versatility than steel scaffolding. Often included components are a load-bearing base plate for the scaffolding, an upright component with connector joins, a horizontal ledger, a transom being a horizontal load-bearing component which holds the batten, board or decking unit, a diagonal brace, the batten or board decking component that makes up the working platform, a coupler to join components together, and a scaffold tie to connect the scaffold to the structure it is placed in front of. The batten, board or decking unit is usually made of one or more wooden planks, but LVL planks and metal plates, or combinations thereof, may also be used. These planks are usually quite heavy due to the relatively high density of the material and the large sizes, especially lengthwise, of the planks or plates.

WO2019/012477 discloses an elongate profiled object such as scaffolds made of a thermoplastic material provided with a reinforcement element. The reinforcement element is used to improve the mechanical properties of the elongate profiled object, in particular the longitudinal or lengthwise stiffness of the elongate object. The reinforcement element may comprise a layer of continuous fiber tape or a fiber-reinforced tape provided at at least part of the peripheral wall. An outer layer may be applied to cover the reinforcmenet element, which may comprise anti-static or fire retardant additive.

Although some known elongate profiled objects such as scaffolds have desirable mechanical properties, they may not have the flame retardancy required in certain situations.

It is an objective of the present invention to provide an elongate profiled object in which above-mentioned and/or other problmes are solved.

Accordingly, the invention provides an elongate profiled object having a cross section, the object comprising a peripheral wall, forming a hollow profile extending in a longitudinal direction, wherein at least part of the peripheral wall is provided with a reinforcement layer extending in at least the longitudinal direction of the elongate profiled object,

wherein the reinforcement layer comprises a tape or of a laminate of tapes, wherein the reinforcement layer has a thickness of at least 0.6 mm and

the tape is made of a first thermoplastic composition, which is a fiber reinforced thermoplastic composition comprising a flame retardant,

wherein the elongate profiled object is made of a second thermoplastic composition.

It was surprisingly found that the elongate profiled object according to the invention has a high flame retardancy, for example at least class D or at least class C as determined by SBI test according to EN13823:2014. Here, at least class D means class D, C, B, A2 or A1. At least class C means class C, B, A2 or A1.

### Reinforcement Layer of Tape or Laminate of Tapes

The elongate profiled object of the invention is provided with a reinforcement layer which is a tape or a laminate of a plurality of tapes. Within the framework of the invention, with ‘laminate’ is meant an arrangement in which at least two plies (layers) of the tapes of the invention are present. For example, such laminate contains 2, 3, 4, 5, 6, 7, 8, 9, 10, or more plies, wherein one ply consists of the tape of the invention. For example, in the laminate, the plies may be positioned such that the tapes are not parallel to each other. In case the tapes are positioned in relation to one other in a substantially 90° angle, such laminate is usually referred to as cross-ply. Laminates of the invention can for example be assembled or processed into two-dimensional or three-dimensional structures, such as, for example, via winding and/or lay-up techniques.

In the context of the invention with ‘tape’ is meant an object whose thickness is very thin in relation to its length and width. That is, the tape has a high width to thickness ratio. Typically the width of a tape is between 1-1500 times, for example 2-100 times, larger than the thickness. The length of the tape can be indefinite. The tape may have a rectangular cross-, but may also have profiled sections (corrugated, ribbed etc.).

The tape of the invention may for example have a thickness in the range from 0.1 to 10 mm and/or a width in the range from 1 to 4000 mm, for example 10 to 400 mm.

The reinforcement layer has a thickness of at least 0.6 mm, for example at least 0.8 mm, at least 1.0 mm, at least 1.2 mm, at least 1.5 mm, and/or at most 5.0 mm, at most 4.0 mm, at most 3.0 mm or at most 2.0 mm.

The tape is made of a first thermoplastic composition, which is a fiber reinforced thermoplastic composition comprising a flame retardant.

### Embodiment 1

In some embodiments, the tape in the reinforcement layer is a tape comprising a plurality of sheathed continuous multifilament strands,

wherein each of the sheathed continuous multifilament strands comprises a core that extends in the longitudinal direction and a polymer sheath which intimately surrounds said core,

wherein each of the cores comprises an impregnated continuous multifilament strand comprising at least one continuous glass multifilament strand, wherein the at least one continuous glass multifilament strand is impregnated with an impregnating agent,

wherein the polymer sheath consists of a thermoplastic polymer composition comprising the flame retardant.

Preferably, the tape is prepared by a process comprising the steps of:

d) providing the plurality of sheathed continuous multifilament strands,

e) placing the plurality of sheathed continuous multifilament strands in parallel alignment in the longitudinal direction,

f) grouping the plurality of sheathed continuous multifilament strands,

wherein steps e) and f) are performed such that the sheathed continuous multifilament strand can be consolidated and

g) subsequently consolidating the plurality of sheathed continuous multifilament strands to form the tape.

Preferably, the sheathed continuous multifilament strands are prepared by the sequential steps of

a) unwinding from a package the continuous glass multifilament strands,

b) applying the impregnating agent to the continuous glass multifilament strands to form the impregnated continuous multifilament strands and

c) applying the sheath of the thermoplastic polymer composition around the impregnated continuous multifilament strands to form the sheathed continuous multifilament strands,

wherein the sheathed continuous multifilament strands of step d) are the sheathed continuous multifilament strands obtained by step c) and

It is possible that the sheathed continuous multifilament strands of step d) are subjected to step e) after cutting. However, preferably, the sheathed continuous multifilament strands of step d) are subjected to step e) without cutting.

In these preferred embodiments, the sheathed continuous multifilament strands formed by step c) (the sheathed continuous multifilament strands of step d)) are directly subjected to step e) without cutting. Thus, in these embodiments, the steps for making the sheathed continuous multifilament strands a)-c) and steps e)-g) are performed in one manufacturing system. The process can be performed as a continuous process, i.e. the continuous glass multiflament strands are continuously unwound for use in the process as the tape is formed continuously by the process.

Such continuous process is much more efficient and faster than a process in which the sheathed continuous multifilament strands formed by step c) are cut and made into bobins and the bobbins are unwound to be placed in parallel alignment in the longitudinal direction in step e). The continuous process is easier to operate since it does not require many separate procedures. This results in a lower manufactruing cost. Moreover, the variations in the properties of tapes produced by the continuous process, such as tensile, flexural and impact properties, are small.

Preferably, the process of the invention involves no cutting until the tape of step g) is formed. Accordingly, preferably, the continuous glass multifilament strands unwound in step a), the impregnated continuous multifilament strands formed in step b), the sheathed continuous multifilament strands formed in step c) are not cut during steps a)-g).

Steps a)-c) are described in detail in WO2009/080281A1, which document is hereby incorporated by reference.

For purpose of the invention with ‘such that the plurality of sheathed continuous multifilament strand can be consolidated’ is meant that the plurality of sheathed continuous multifilament strands are placed in such a vicinity to one another that they can be melted together.

Steps e) and f) can be performed by first placing the plurality of sheathed continuous multifilament strands in parallel alignment in the longitudinal direction after which the plurality of sheathed continuous multifilament strands are grouped. However, steps e) and f) can also be performed by first grouping the plurality of sheathed continuous multifilament strands after which the plurality of sheathed continuous multifilament strands is placed in a parallel alignment in the longitudinal direction.

Steps e) and f) can also be performed in one and the same step, for example by pulling the plurality of sheathed continuous multifilament strand through a slit die (a die with an opening in the form of a rectangle, preferably a slit die having an opening with dimensions that are comparable to the thickness and width dimensions of the tape to be produced).

Step g) of the consolidation of the plurality of sheathed continuous multifilament strand for form the tape is performed in a consolidation unit. An example of a consolidation unit includes but is not limited to a belt press.

Step g) is preferably performed by sequential steps of

g1) heating and exerting pressure on the plurality of sheathed continuous multifilament strand to obtain a product made of consolidated strands and

g2) cooling and solidifying the product obtained by step g1), e.g. by chill rolls, a water bath, a blower a fan or a high speed air knife.

Step g1) is preferably performed e.g. by sequential steps of

g1a) melting the plurality of sheathed continuous multifilament strand to merge the strands, e.g. by hot rolls, flat belts, an oven or a belt press and

g1b) exerting pressure on the product obtained by step g1a) to adjust its thickness, e.g. by calendaring rolls.

Step g1a) heats the plurality of sheathed continuous multifilament strand to melt them, so that they will be merged. This also improves the impregnation of the impregnated continuous multiflamet strands in the thermoplastic polymer, which results in improved tape properties. Examples of units for performing step g1a) include hot rolls, flat belts, an oven and a belt press. The use of hot rolls for step g1a) has an advantage that it can be performed at a high speed. The advantage of using flat belts or belt press is that the tape directly contact with the belt to achieve a good heat transfer, which results in a better impregnation. Step g1b) is performed at a lower temperature than the previous step, which further improves the impregnation of the impregnated continuous multiflamet strands in the thermoplastic polymer. This further achieves a good surface quality. Step g2) results in the final solid tape. This can be performed using chill rolls, which advantageously achieves a relatively slow cooling to reduce shrinkage. Some other possible cooling methods are water bath, blower, fan, high speed air knife, etc. These technologies can reach fast cooling, especially water bath.

The process may further comprise the step h) of cutting the tape obtained by step g) into desired length, which may be stacked or wound.

The core of each of the sheathed continuous multifilament strands comprises an impregnated continuous multifilament strand, for example one or more impregnated continuous multifilament strands. Preferably, the one or more impregnated continuous multifilament strands form at least 90 wt %, more preferably at least 93 wt %, even more preferably at least 95 wt %, even more preferably at least 97 wt %, even more preferably at least 98 wt %, for example at least 99 wt % of the core. In a preferred embodiment, each core consists of the one or more impregnated continuous multifilament strands.

In the context of the invention with ‘extends in the longitudinal direction’ is meant ‘oriented in the direction of the long axis of the sheathed continuous multifilament strand’.

The impregnated continuous multifilament strand is prepared from a continuous glass multifilament strand and an impregnating agent.

The term intimately surrounding as used herein is to be understood as meaning that the polymer sheath substantially entirely contacts the core. Said in another way the sheath is applied in such a manner onto the core that there is no deliberate gap between an inner surface of the sheath and the core containing the impregnated continuous mutifilament strands. A skilled person will nevertheless understand that a certain small gap between the polymer sheath and the glass filaments may be formed as a result of process variations. Preferably, therefore, the polymer sheath comprises less than 5 wt. % of said filament, preferably less than 2 wt. % of filament based on the total weight of the polymer sheath.

Preferably, the thickness of the polymer sheath in the sheathed continuous multifilament strand is between 200 and 1500 micrometer, for example 500 and 1500 micrometer.

### Thermoplastic Polymer Composition of Polymer Sheath

The polymer sheath consists of a thermoplastic polymer composition. Preferably, the melt flow rate (MFR) of the thermoplastic polymer composition is in the range from 20 to 150 dg/min, preferably in the range from 25 to 120 dg/min, for example in the range from 35 to 100 dg/min as measured according to ISO1133 (2.16 kg/230° C.).

### Thermopolastic Polymer in Thermoplastic Polymer Composition of Polymer Sheath

The thermoplastic polymer composition comprises a thermoplastic polymer. Suitable examples of thermoplastic polymers include but are not limited to polyamide, such as polyamide 6, polyamide, 66 or polyamide 46; polyolefins, for example polypropylenes and polyethylenes; polyesters, such as polyethylene terephthalate, polybutylene terephthalate; polycarbonates; polyphenylene sulphide; polyurethanes and and mixtures thereof.

The thermoplastic polymer is preferably a polyolefin, more preferably a polyolefin chosen from the group of polypropylenes or elastomers of ethylene and α-olefin comonomer having 4 to 8 carbon atoms, and any mixtures thereof.

In one embodiment, preferably the thermoplastic polymer composition comprises at least 80 wt % of a thermoplastic polymer, for example at least 90 wt % polyolefin, at least 93 wt %, for example at least 95 wt %, for example at least 97 wt % of thermoplastic polymer, for example at least 98 wt % or for example at least 99 wt % of a thermoplastic polymer based on the thermoplastic polymer composition. In a special embodiment, the thermoplastic polymer composition consists of a thermoplastic polymer.

In another embodiment, the thermoplastic polymer composition comprises at least 60 wt %, for example at least 70 wt %, for example at least 75 wt % and/or at most 99 wt %, for example at most 95 wt %, for example at most 90 wt % thermoplastic polymer.

The polypropylene may for example be a propylene homopolymer or a random propylene-α-olefin copolymer or a heterophasic propylene copolymer.

A propylene homopolymer can be obtained by polymerizing propylene under suitable polymerization conditions. A propylene copolymer can be obtained by copolymerizing propylene and one or more other α-olefins, preferably ethylene, under suitable polymerization conditions. The preparation of propylene homopolymers and copolymers is, for example, described in Moore, E. P. (1996) Polypropylene Handbook. Polymerization, Characterization, Properties, Processing, Applications, Hanser Publishers: New York.

The α-olefin in the random propylene α-olefin copolymer is for example an α-olefin chosen from the group of α-olefin having 2 or 4 to 10 C-atoms, preferably ethylene, 1-butene, 1-hexene or any mixtures thereof. The amount of of α-olefin is preferably at most 10 wt % based on the propylene α-olefin copolymer, for example in the range from 2-7wt % based on the propylene α-olefin copolymer.

Polypropylenes can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Heterophasic propylene copolymers are generally prepared in one or more reactors, by polymerization of propylene in the presence of a catalyst and subsequent polymerization of a propylene-α-olefin mixture. The resulting polymeric materials are heterophasic, but the specific morphology usually depends on the preparation method and monomer ratio.

The heterophasic propylene copolymer as defined herein consists of a propylene-based matrix and a dispersed ethylene-α-olefin copolymer.

The propylene-based matrix typically forms the continuous phase in the heterophasic propylene copolymer.

The propylene-based matrix consists of a propylene homopolymer and/or a propylene-α-olefin copolymer consisting of at least 70% by mass of propylene and up to 30% by mass of α-olefin, for example ethylene, for example consisting of at least 80% by mass of propylene and up to 20% by mass of α-olefin, for example consisting of at least 90% by mass of propylene and up to 10% by mass of α-olefin, based on the total mass of the propylene-based matrix.

Preferably, the α-olefin in the propylene-α-olefin copolymer is selected from the group of α-olefins having 2 or 4-10 carbon atoms and is preferably ethylene.

Preferably, the propylene-based matrix consists of a propylene homopolymer.

The melt flow index (MFI) of the propylene-based matrix (before it is mixed into the composition of the invention) may be in the range of for example 0.3 to 200 dg/min as measured according to ISO1133 (2.16 kg/230° C.).

The propylene-based matrix is for example present in an amount of 50 to 85 wt % based on the total heterophasic propylene copolymer.

Besides the propylene-based matrix, the heterophasic propylene copolymer also consists of a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form.

The MFI of the dispersed ethylene α-olefin copolymer may vary between wide range and may for example be in the range from for example be in the range from 0.001 to 10 dg/min (measured according to ISO1133 (2.16 kg/230° C. as calculated using the following formula:

$$M F R E P R = 1 {0}^{∧} ( \frac{\begin{matrix}Log MFR heterophasic - \\ matrix content * Log MFRPP\end{matrix}}{rubber content} )$$

wherein MFR heterophasic is the melt flow rate of the heterophasic propylene copolymer measured according to ISO1133 (2.16 kg/230° C.),

MFR PP is the MFR of the propylene-based matrix of the heterophasic propylene copolymer measured according to ISO1133 (2.16 kg/230° C.)

matrix content is the amount of propylene-based matrix in the heterophasic propylene copolymer in wt % and

rubber content is the amount of ethylene α-olefin copolymer in the heterophasic propylene copolymer in wt %.

The dispersed ethylene-α-olefin copolymer is for example present in an amount of 50 to 15 wt % based on the total heterophasic propylene copolymer.

For example, the amount of ethylene in the ethylene-α-olefin copolymer (RCC2) is in the range of 20-65 wt % based on the ethylene-α-olefin copolymer.

The amounts of the propylene-based matrix and the dispersed ethylene-α-olefin copolymer, as well as the amount of ethylene in the ethylene α-olefin copolymer may be determined by ¹³C-NMR, as is well known in the art.

In the heterophasic polypropylene, the sum of the total weight of the propylene-based matrix and the total weight of the dispersed ethylene-α-olefin copolymer is 100 wt %

The α-olefin in the ethylene-α-olefin copolymer is preferably chosen from the group of α-olefins having 3 to 8 carbon atoms and any mixtures thereof, preferably the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer. Examples of suitable α-olefins having 3 to 8 carbon atoms, which may be employed as ethylene comonomers to form the ethylene α-olefin copolymer include but are not limited to propylene, 1-butene, 1-pentene, 4-methyl-1-pentene, 1-hexen, 1-heptene and 1-octene.

The elastomer of ethylene and α-olefin comonomer having 4 to 8 carbon atoms may for example have a density in the range from 0.850 to 0.915 g/cm³. Such elastomers are sometimes also referred to as plastomers.

The α-olefin comonomer in the elastomer is preferably an acyclic monoolefin such as 1-butene, 1-pentene, 1-hexene, 1-octene, or 4-methylpentene.

Accordingly, the elastomer is preferably selected from the group consisting of ethylene-1-butene copolymer, ethylene-1-hexene copolymer, ethylene-1-octene copolymer and mixtures thereof, more preferably wherein the elastomer is selected from ethylene-1-octene copolymer. Most preferably, the elastomer is an ethylene-1-octene copolymer.

Preferably, the density of the elastomer is at least 0.865 g/cm³ and/or at most 0.910 g/cm³. For example, the density of the elastomer is at least 0.850, for example at least 0.865, for example at least 0.88, for example at least 0.90 and/or for example at most 0.915, for example at most 0.910, for example at most 0.907, for example at most 0.906 g/cm³. More preferable the density of the elastomer is in the range from 0.88 up to an including 0.907 g/cm³, most preferably, the density of the elastomer is in the range from 0.90 up to and including 0.906 g/cm³.

Elastomers which are suitable for use in the current invention are commercially available for example under the trademark EXACT™ available from Exxon Chemical Company of Houston, Tex. or under the trademark ENGAGE™ polymers, a line of metallocene catalyzed plastomers available from Dow Chemical Company of Midland, Mich. or under the trademark TAFMER™ available from MITSUI Chemicals Group of Minato Tokyo or under the trademark Nexlene™ from SK Chemicals.

The elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomers may also be prepared using traditional types of heterogeneous multi-sited Ziegler-Natta catalysts.

Preferably, the elastomer has a melt flow index of 0.1 to 40 dg/min (ISO1133, 2.16 kg, 190° C.), for example at least 1 dg/min and/or at most 35 dg/min. More preferably, the elastomer has a melt flow index of at least 1.5 dg/min, for example of at least 2 dg/min, for example of at least 2.5 dg/min, for example of at least 3 dg/min, more preferably at least 5 dg/min and/or preferably at most 30 dg/min, more preferably at most 20 dg/min, more preferably at most 10 dg/min measured in accordance with ISO 1133 using a 2.16 kg weight and at a temperature of 190° C.

Preferably, the amount of ethylene incorporated into the elastomer is at least 50 mol %. More preferably, the amount of ethylene incorporated into the elastomer is at least 57 mol %, for example at least 60 mol %, at least 65 mol % or at least 70 mol %. Even more preferably, the amount of ethylene incorporated into the elastomer is at least 75 mol %. The amount of ethylene incorporated into the elastomer may typically be at most 97.5 mol %, for example at most 95 mol % or at most 90 mol %.

### Flame Retardant in Thermoplastic Polymer Composition of Polymer Sheath

The thermoplastic polymer composition of the polymer sheath comprises a flame retardant.

Preferably, the flame retardant is a mixture of an organic phosphate compound, an organic phosphoric acid and a zinc oxide; wherein the weight ratio of phosphate compound to phosphoric acid compound is from 1:0.01 to 1:2 and wherein the zinc oxide is present in an amount of from 2-10 wt. % based on the weight of the flame retardant. In an embodiment, the flame-retardant is a mixture of piperazine pyrophosphate, phosphoric acid and zinc oxide, more preferably a mixture of 50-60 wt. % of piperazine pyrophosphate, 35-45 wt. % phosphoric acid and 3-6 wt. % of zinc oxide, all based on the total weight of the thermoplastic polymer composition. For the avoidance of doubt the flame retardant is a halogen-free flame retardant.

In such mixture, the weight ratio of organic phosphate compound to phosphoric acid compound may be from 1:0.01 to 1:2. Preferably the weight ratio is from 1:1 to 1:2.

The organic phosphate compound in the mixture may be selected from piperazine pyrophosphate, piperazine polyphosphate and one or more combinations thereof. The phosphoric acid compounds in the mixture may be selected from phosphoric acid, melamine pyrophosphate, melamine polyphosphates, melamine phosphate and one or more combinations thereof. It is preferred that the phosphoric acid compound is melamine phosphate. The zinc oxide may be used in an amount of from 2-10 wt. %, more preferably from 3-6 wt. % based on the weight of the flame retardant.

An example of a suitable flame retardant is a mixture of 50-60 wt. % of piperazine pyrophosphate, 35-45 wt. % phosphoric acid and 3-6 wt. % of zinc oxide, all based on the total weight of the flame retardant. This mixture is commercially available as e.g. ADK STAB FP-2200 available from Adeka Palmarole.

A further example of a suitable flame retardant is commercially available as ADK STAB FP-2100 JC.

Preferably, the amount of the flame retardant is from 10 to 35 wt. % based on the weight of the first thermoplastic polymer composition. Higher amounts, such as from 20 to 35 wt. % may be required for applications that need to fulfill class C according to EN 13823:2014. For class D according to EN 13823:2014 lower amounts such as 10 to 20 wt % may suffice.

### Other Additives in Thermoplastic Polymer Composition of Polymer Sheath

The thermoplastic polymer composition of the polymer sheath may contain other usual additives, for instance nucleating agents and clarifiers, stabilizers, release agents, fillers, peroxides, plasticizers, anti-oxidants, lubricants, antistatics, cross linking agents, scratch resistance agents, high performance fillers, pigments and/or colorants, impact modifiers, blowing agents, acid scavengers, recycling additives, coupling agents, anti-microbials, anti-fogging additives, slip additives, anti-blocking additives, polymer processing aids and the like. Such additives are well known in the art. The skilled person will know how to choose the type and amount of additives such that they do not detrimentally influence the aimed properties. In a special embodiment, the thermoplastic polymer composition consists of the thermoplastic polymer and additives. The amount of the additives may e.g. be 0.1 to 5.0 wt % of the first thermoplastic polymer composition.

### Core

The sheathed continuous multifilament strands comprises a core that extends in the longitudinal direction. The core comprises an impregnated continuous multifilament strand comprising at least one continuous glass multifilament strand, wherein the at least one continuous glass multifilament strand is impregnated with an impregnating agent.

### Glass Fibres of Core

Glass fibres are generally supplied as a plurality of continuous, very long filaments, and can be in the form of strands, rovings or yarns. A filament is an individual fibre of reinforcing material. A strand is a plurality of bundled filaments. Yarns are collections of strands, for example strands twisted together. A roving refers to a collection of strands wound into a package.

For purpose of the invention, a glass multifilament strand is defined as a plurality of bundled glass filaments.

Glass multifilament strands and their preparation are known in the art.

The filament density of the continuous glass multifilament strand may vary within wide limits. For example, the continuous glass multifilament strand may have at least 500, for example at least 1000 glass filaments/strand and/or at most 10000, for example at most 5000 grams per 1000 meter. Preferably, the amount of glass filaments/strands is in the range from 500 to 10000 grams per 1000 meterglass filaments/strand.

The thickness of the glass filaments is preferably in the range from 5 to 50 μm, more preferably from 10 to 30 μm, even more preferably from 15 to 25 μm. Usually the glass filaments are circular in cross section meaning the thickness as defined above would mean diameter. The glass filaments are generally circular in cross section.

The length of the glass filaments is in principle not limited as it is substantially equal to the length of the sheathed continuous multifilament strand. For practical reasons of being able to handle the tape however, it may be necessary to cut the sheathed continuous multifilament strand into a shorter strand. For example the length of the sheathed continuous multifilament strand is at least 1 m, for example at least 10 m, for example at least 50 m, for example at least 100 m, for example at least 250 m, for example at least 500 m and/or for example at most 25 km, for example at most 10 km.

Preferably, the continuous glass multifilament strand in the tape of the invention comprises at most 2 wt %, preferably in the range from 0.10 to 1 wt % of a sizing based on the continuous glass multifilament strand. The amount of sizing can be determined using ISO 1887:2014.

A sizing composition is typically applied to the glass filaments before the glass filaments are bundled into a continuous glass multifilament strand.

Suitable examples of sizing compositions include solvent-based compositions, such as an organic material dissolved in aqueous solutions or dispersed in water and melt- or radiation cure-based compositions. Preferably, the sizing composition is an aqueous sizing composition.

As described in the art, e.g. in documents EP1460166A1 , EP0206189A1 or U.S. Pat. No. 4,338,233, the aqueous sizing composition may include film formers, coupling agents and other additional components.

The film formers are generally present in effective amount to protect fibres from interfilament abrasion and to provide integrity and processability for fibre strands after they are dried. Suitable film formers are miscible with the polymer to be reinforced. For example; for reinforcing polypropylenes, suitable film formers generally comprise polyolefin waxes.

The coupling agents are generally used to improve the adhesion between the matrix thermoplastic polymer and the fibre reinforcements. Suitable examples of coupling agents known in the art as being used for the glass fibres include organofunctional silanes. More particularly, the coupling agent which has been added to the sizing composition is an aminosilane, such as aminomethyl-trimethoxysilane, N-(beta-aminoethyl)-gamma-aminopropyl-trimethoxysilane, gamma-aminopropyl-trimethoxysilane gamma-methylaminopropyl-trimethoxysilane, delta-aminobutyl-triethoxysilane, 1,4-aminophenyl-trimethoxysilane. Preferably, in the tape of the invention, the sizing composition contains an aminosilane to enable a good adhesion to the thermoplastic matrix. The sizing composition may further comprise any other additional components known to the person skilled in the art to be suitable for sizing compositions. Suitable examples include but are not limited to lubricants (used to prevent damage to the strands by abrasion) antistatic agents, crosslinking agents, plasticizers, surfactants, nucleation agents, antioxidants, pigments as well as mixtures thereof.

Typically, after applying the sizing composition to the glass filaments, the filaments are bundled into the continuous glass multifilament strands and then wound onto bobbins to form a package.

### Impregnating Agent

In the tape of the invention, the impregnated continuous multifilament strand is prepared from a continuous glass multifilament strand and an impregnating agent and in particular by applying an impregnating agent to the continuous glass multifilament strand preferably in an amount from 0.50 to 18.0 wt %, for example from 0.5 to 10.0 wt % or for example from 10.0 to 18.0 wt % based on the sheathed continuous multifilament strands.

The optimal amount of impregnating agent applied to the continuous glass multifilament strand depends on the polymer sheath, on the size (diameter) of the glass filaments forming the continuous glass strand, and on the type of sizing composition. Typically, the amount of impregnating agent applied to the continuous glass multifilament strand is for example at least 0.50 wt %, preferably at least 1.0 wt %, preferably at least 1.5 wt %, preferably at least 2 wt %, preferably at least 2.5 wt % and/or at most 10.0 wt %, preferably at most 9.0 wt %, more preferably at most 8.0 wt %, even more preferably at most 7.0 wt %, even more preferably at most 6.0 wt %, even more preferably at most 5.5 wt %, or for example at least 10.0 wt %, preferably at least 11 wt %, preferably at least 12 wt % and/or at most 18 wt %, preferably at most 16 wt %, preferably at most 14% based on the amount of sheathed continuous multifilament strands. Preferably, the amount of impregnating agent is in the range from 1.5 to 8 wt %, even more preferably in the range from 2.5 wt % to 6.0 wt % based on the sheathed continuous multifilament strand. A higher amount of impregnating agent increases the Impact Energy per unit of thickness (J/mm). However, for reasons of cost-effectiveness and low emissions (volatile organic compounds) and mechanical properties, the amount of impregnating agent should also not become too high.

For example, the ratio of impregnating agent to continuous glass multifilament strand is in the range from 1:4 to 1:30, preferably in the range from 1:5 to 1:20.

Preferably, the viscosity of the impregnating agent is in the range from 2.5 to 200 cSt at 160° C., more preferably at least 5.0 cSt, more preferably at least 7.0 cSt and/or at most 150.0 cSt, preferably at most 125.0 cSt, preferably at most 100.0 cSt at 160° C.

An impregnating agent having a viscosity higher than 100 cSt is difficult to apply to the continuous glass multifilament strand. Low viscosity is needed to facilitate good wetting performance of the fibres, but an impregnating agent having a viscosity lower than 2.5 cSt is difficult to handle, e.g., the amount to be applied is difficult to control; and the impregnating agent could become volatile. For purpose of the invention, unless otherwise stated, the viscosity of the impregnating agent is measured in accordance with ASTM D 3236-15 (standard test method for apparent viscosity of hot melt adhesives and coating materials, Brookfield viscometer Model RVDV 2, #27 spindle, 5 r/min) at 160° C.

Preferably, the melting point of (that is the lowest melting temperature in a melting temperature range) the impregnating agent is at least 20° C. below the melting point of the thermoplastic polymer composition. More preferably, the impregnating agent has a melting point of at least 25 or 30° C. below the melting point of the thermoplastic polymer composition. For instance, when the thermoplastic polymer composition has a melting point of about 160° C., the melting point of the impregnating agent may be at most about 140° C.

Suitable impregnating agents are compatible with the thermoplastic polymer to be reinforced, and may even be soluble in said polymer. The skilled man can select suitable combinations based on general knowledge, and may also find such combinations in the art.

Suitable examples of impregnating agents include low molar mass compounds, for example low molar mass or oligomeric polyurethanes, polyesters such as unsaturated polyesters, polycaprolactones, polyethyleneterephthalate, poly(alpha-olefins), such as highly branched polyethylenes and polypropylenes, polyamides, such as nylons, and other hydrocarbon resins.

For reinforcing polypropylenes, the impregnating agent preferably comprises highly branched poly(alpha-olefins), such as highly branched polyethylenes, modified low molecular weight polypropylenes, mineral oils, such as, paraffin or silicon and any mixtures of these compounds.

The impregnating agent preferably comprises at least 20 wt %, more preferably at least 30 wt %, more preferably at least 50 wt %, for example at least 99.5 wt %, for example 100 wt % of a branched poly(alpha-olefin), most preferably a branched polyethylene. To allow the impregnating agent to reach a viscosity of from 2.5 to 200 cSt at 160° C., the branched poly(alpha-olefin) may be mixed with an oil, wherein the oil is chosen from the group consisting of of mineral oils, such as a paraffin oil or silicon oil; hydrocarbon oils; and any mixtures thereof.

Preferably, the impregnating agent is non-volatile, and/or substantially solvent-free. In the context of the present invention, non-volatile means that the impregnating agent has a boiling point or range higher than the temperatures at which the impregnating agent is applied to the continuous multifilament glass strand. In the context of present invention, “substantially solvent-free” means that impregnating agent contains less than 10 wt % of solvent, preferably less than 5 wt % of solvent based on the impregnating agent. In a preferred embodiment, the impregnating agent does not contain any organic solvent.

The impregnating agent may further be mixed with other additives known in the art. Suitable examples include lubricants; antistatic agents; UV stabilizers; plasticizers; surfactants; nucleation agents; antioxidants; pigments; dyes; and adhesion promoters, such as a modified polypropylene having maleated reactive groups; and any combinations thereof, provided the viscosity remains within the desired range. Any method known in the art may be used for applying the liquid impregnating agent to the continuous glass multifilament strand. The application of the liquid impregnating agent may be performed using a die. Other suitable methods for applying the impregnating agent to the continuous multifilament strands include applicators having belts, rollers, and hot melt applicators. Such methods are for example described in documents EP0921919B1, EP0994978B1, EP0397505B1, WO2014/053590A1 and references cited therein. The method used should enable application of a constant amount of impregnating agent to the continuous multifilament strand.

Preferably, the amount of impregnated continuous multifilament strand is in the range of 10 to 70 wt %, for example in the range from 15 to 70 wt %, for example in the range from 20 to 70 wt % or for example in the range from 25 to 70 wt % based on the sheathed continuous multifilament strands. Preferably, the sum of the amount of impregnated continuous multifilament strand and the polymer sheath is 100 wt %.

### Embodiment 2

In some embodiments, the tape in the reinforcement layer is a fiber-reinforced composite comprising:

a matrix material including a thermoplastic polymer composition comprising the flame retardant; and

a non-woven fibrous region comprising a plurality of continuous fibers dispersed in the matrix material;

wherein the width and the length of the non-woven fibrous region are substantially equal to the width and the length, respectively, of the fiber-reinforced composite;

wherein the non-woven fibrous region has a mean relative fiber area coverage (RFAC) (%) of from 65 to 90 and a coefficient of variance (COV) (%) of from 3 to 20; and wherein each of the plurality of continuous fibers is substantially aligned with the length of the fiber-reinforced composite.

As the thermoplastic polymer composition of the matrix material, the thermoplastic polymer composition which makes up the polymer sheath explained in relation to Embodiment 1 may suitably be used. Thus, the description of the thermoplastic polymer composition which makes up the polymer sheath explained in relation to Embodiment 1, including the description on the flame retardant, fully applies to the thermoplastic polymer composition of the matrix material of Embodiment 2.

As the continuous fibers in the fiber-reinforced composite, the continuous glass multifilamet strand comprised in the core explained in relation to Embodiment 1 may suitably be used. Thus, the description of the continuous glass multifilamet strand comprised in the core explained in relation to Embodiment 1 fully applies to the continuous fibers in the fiber-reinforced composite of Embodiment 2.

The fiber-reinforced composite can include, by volume, at least 35 to 70%, preferably 40 to 65%, or more preferably 45 to 55%, of the plurality of continuous fibers.

Further details of the fiber-reinforced composite are given in WO2016/142784, incorporated herein by reference.

### Elongate Profiled Object

### Second Thermoplastic Composition

The elongate profiled object is made of a second thermoplastic composition.

The second thermoplastic composition comprises a thermoplastic polymer, optional glass fibers and an optional flame retardant.

As the thermoplastic polymer in the second thermoplastic composition, the thermopolastic polymer in the thermoplastic polymer composition which makes up the polymer sheath explained in relation to Embodiment 1 may suitably be used. Thus, the description of the thermoplastic polymer in the thermoplastic polymer composition which makes up the polymer sheath explained in relation to Embodiment 1 fully applies to the thermoplastic polymer in the second thermoplastic composition.

Preferably, the thermoplastic polymer in the first thermoplastic composition and the thermoplastic polymer in the second thermoplastic composition are of the same type. This is advantageous in terms of compatibility and adhesion strength between the elongated profiled object and the reinforcement layer.

Preferably, the first thermoplastic composition and/or the second thermoplastic composition comprises a polyolefin, preferably polypropylene. More preferably, the first thermoplastic composition and the second thermoplastic composition comprises a polyolefin, preferably polypropylene.

As the optional glass fibers in the second thermoplastic composition, the continuous glass multifilamet strand comprised in the core explained in relation to Embodiment 1 may suitably be used. Thus, the description of the continuous glass multifilamet strand comprised in the core explained in relation to Embodiment 1 fully applies to the optinal glass fibers in the second thermoplastic composition.

For example, the second thermoplastic composition can comprise STAMAX™ materials, a long glass fiber reinforced polypropylene commercially available from SABIC, for instance is pellet form with a typical length of about 15 mm and a diameter of about 3 mm.

Preferably, the second thermoplastic composition comprises a flame retardant. As the flame retardant in the second thermoplastic composition, the flame retardant in the first thermoplastic composition may suitably be used. Thus, the description of the flame retardant in the first thermoplastic polymer composition fully applies to the flame retardant in the second thermoplastic composition.

Preferably, the amount of the flame retardant is 10 to 35 wt. %, for example 10 to 20 wt % or 20 to 35 wt % based on the weight of the second thermoplastic polymer composition.

### Shapes and Dimensions of the Elongate Profiled Object

The elongate profiled objects may include sections, plates, pipes, planks and the like. The peripheral wall may have a thickness of at least 1 mm, preferably a thickness of 2-5 mm. Such elements can be reduced, for example cut, to the desired length. When used as a plank, for instance as a scaffolding plank, a weight reduction with respect to a similarly sized LVL or wooden plank may be achieved.

The cross section of the elongate object can have several forms, such as square, rectangular, circular, or any polygonal shape. For scaffolding planks, the elongate profiled object will have a rectangular shaped cross section, wherein the outer wall comprises two longitudinal profile sidewalls, an upper wall and a bottom wall. The upper and bottom walls have a larger width W than the height H of the sidewalls. For such a shape, the reinforcement element is provided at the upper wall and/or bottom wall, while covering at least part of the upper wall and/or the bottom wall.

Further details of the elongate profiled object are given in WO2019/012477, incorporated herein by reference.

### Cover Layer

The elongated profiled object may further be provided with a thermoplastic polymer film provided over the tape or the laminate of tapes.

Preferably, the thermoplastic polymer film is made of a composition comprising a thermoplastic polymer, an optional flame retardant and optional filler such as talc.

As the thermoplastic polymer in the thermoplastic polymer film, the thermopolastic polymer in the thermoplastic polymer composition which makes up the polymer sheath explained in relation to Embodiment 1 may suitably be used. Thus, the description of the thermoplastic polymer in the thermoplastic polymer composition which makes up the polymer sheath explained in relation to Embodiment 1 fully applies to the thermoplastic polymer in the thermoplastic polymer film.

Preferably, the thermoplastic polymer film comprises a flame retardant. As the flame retardant in the thermoplastic polymer film, the flame retardant in the first thermoplastic composition may suitably be used. Thus, the description of the flame retardant in the first thermoplastic polymer composition fully applies to the flame retardant in the thermoplastic polymer film.

Preferably, the amount of the flame retardant is 10 to 35 wt. % or 15 to 25 wt % based on the weight of the thermoplastic polymer film.

Preferably, the amount of the talc is 10 to 35 wt. % or 15 to 25 wt % based on the weight of the thermoplastic polymer film.

The thermoplastic polymer film may comprise e.g. SABIC 57F9722 PP.

For example, the thermoplastic polymer film has a thickness of 0.5 to 1.5 mm.

### Method for Manufacturing Profiled Object

Furthermore, the invention relates to a method for manufacturing a profiled object as described above, the method comprising: molding a second thermoplastic polymer composition to provide an elongate profiled object having a peripheral wall forming a hollow profile extending in a longitudinal direction; and providing a reinforcement layer at at least part of the peripheral wall.

The elongate profiled object may be molded using extrusion molding (extrusion) or any other suitable form of molding, such as injection molding. The reinforcement layer may be provided on an already molded elongate object. This can be done in a separate processing step, such as overlaying the peripheral wall with an at least partially covering reinforcement layer, using for example a double belt press, a heat gun or laminating.

Alternatively, the reinforcement layer may be provided onto the elongate profiled object by means of co-extrusion, either in a single process step, or in a second downstream process step of a multiple step process. The reinforcement layer may be co-extruded onto the peripheral wall of the elongate profile object, either simultaneously or in separate downstream steps.

Preferably, the elongate profiled object according to the invention has a high flame retardancy, for example at least class D or at least class C as determined by SBI test according to EN13823:2014.

### Further Aspects

The invention further relates to a tape comprising a plurality of sheathed continuous multifilament strands,

wherein each of the sheathed continuous multifilament strands comprises a core that extends in the longitudinal direction and a polymer sheath which intimately surrounds said core,

wherein each of the cores comprises an impregnated continuous multifilament strand comprising at least one continuous glass multifilament strand, wherein the at least one continuous glass multifilament strand is impregnated with an impregnating agent,

wherein the polymer sheath consists of a thermoplastic polymer composition comprising a flame retardant.

The invention further relates to a fiber-reinforced composite comprising:

a matrix material including a thermoplastic polymer composition comprising a flame retardant; and

a non-woven fibrous region comprising a plurality of continuous fibers dispersed in the matrix material;

wherein the width and the length of the non-woven fibrous region are substantially equal to the width and the length, respectively, of the fiber-reinforced composite;

wherein the non-woven fibrous region has a mean relative fiber area coverage (RFAC) (%) of from 65 to 90 and a coefficient of variance (COV) (%) of from 3 to 20; and wherein each of the plurality of continuous fibers is substantially aligned with the length of the fiber-reinforced composite.

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

### Materials Used

A heterophasic propylene copolymer having a melt flow rate of 66 dg/min as measured according to ISO1133 at 230° C./2.16 kg was used (PP1). The amount of ethylene-propylene copolymer in the heterophasic propylene copolymer (RC) was 18.5 wt %. The amount of ethylene in the ethylene-propylene copolymer (RCC2) was 55 wt % and the total ethylene amount in the heterophasic propylene copolymer (TC2) was 10 wt %. The matrix was a propylene homopolymer having a melt flow rate as measured according to ISO1133 at 230° C. was 156 dg/min, the melt flow rate of the ethylene-propylene copolymer as calculated as described herein was 1.5 dg/g.

As continuous glass multifilament strand a glass roving containing a sizing agent, which roving has a diameter of 19 micron and a tex of 3000 (tex means grams glass per 1000 m) was used. Its amount based on the sheathed continuous multifilament strand is indicated herein as GF (wt %).

As a coupling agent (CA) Exxelor PO1020, a maleic anhydride functionalized homo polypropylene, which is commercially available from Exxon Mobile, was used.

As an impregnating agent (IA), a highly branched polyethylene wax having a viscosity of 49 mPa·s as measured according to ASTM D 3236-15 at 100° C. was used (Dicera 13082 Paramelt).

As a thermal stabilizer (TS), Irganox® B 225 was used, which is commercially available from BASF and which is a blend of 50 wt % tris(2,4-ditert-butylphenyl)phosphite and 50 wt % pentaerythritol tetrakis[3-[3,5-di-tert-butyl-4-hydroxyphenyl]propionate].

As a UV stabilizer, Sabostab UV 119, a hindered amine light stabilizer (HALS) from CIBA which is commercially available from BASF, was used.

As a flame retardant (FR), ADK STAB FP-2200S, commercially available from Adeka Palmarole was used. This material is a mixture comprising piperaxine pyrophosphate, phosphoric acid compound and zinc oxide.

### Step 1. Preparation of Tape

### Method 1

### Step 1-1. Preparation of Sheathed Continuous Multifilament Strands (Wire-Coating)

Single sheathed continuous multifilament strands were prepared using the amount of different ingredients as given in Table 1 using the wire coating process as described in details in the examples of WO2009/080281A1.

As a first step, the impregnating agent was molten and mixed at a temperature of 160° C. and applied to the continuous glass multifilament strands after unwinding from the package, by using a wax impregnation unit as described in WO2014/053590 A1.

The PP1 was fed to the main feeder, the additives (HALS, CA, TS) are mixed and fed to the additives feeder while the FR was fed to the side feeder of a 75 mm twin screw extruder (manufactured by Berstorff, screw L/D ratio of 34) at a temperature of about 250° C. to obtain a molten polypropylene matrix composition.

The molten polypropylene matrix composition was then used to sheath the impregnated continuous glass multifilament strands using an extruder-head wire-coating die having a die-hole of 2.8 mm. The sheathing step was performed in-line directly after the impregnating step.

The line speed for impregnating and sheathing was 60 m/min. After cooling, strands were wound onto bobbins. The length of the obtained strands was approximately 400 m long.

TABLE 1
Composition details of sheathed continuous multifilament
strands produced using method 1A

| Wire coating | Non-FR tape | FR tape |
|---|---|---|
| PP1 (wt %) | 26.24 | 21.87 |
| GF (wt %) | 60.30 | 60.30 |
| CA (wt %) | 3.00 | 3.00 |
| Impregnating | 10.00 | 5.00 |
| agent (wt %) | | |
| UV stabilizer | 0.06 | 0.06 |
| (wt %) | | |
| Thermal | 0.40 | 0.40 |
| stabilizer | | |
| (wt %) | | |
| FR (wt %) | 0.00 | 9.37 |

### Step 1-2. Preparation of Tapes from Sheathed Continuous Multifilament Strands Produced in Step 1-1

In this step, tapes were prepared using the strands obtained in step 1-1. First, the strands were put from the bobbin onto an unwinder and then they were unwound from the unwinder. Subsequently, strands were rolled onto a metal cylinder covered with a Teflon® layer to prevent sticking of the strands on the surface of cylinder. Then, the cylinder was placed into an oven having a temperature of 172° C. After the temperature of the strand surface reached 172° C. and all the sheath had melted and all strands were merged together (as observed visually), the cylinder was taken out of the oven and placed in an open area for 1.5 hours to achieve free air cooling. The tape obtained was then again placed into an oven having a temperature of 172° C. and weights were placed onto the tape. After the temperature reached 172° C. the heating of the oven was shut down and the tape was obtained by slow cooling.

After the slow cooling, the tape was consolidated by using a double belt press machine (KFK-XL 1900 from Meyer, RutzDouble) to improve tape quality. This machine has four heating zones with a length of 4.5 m and two cooling zones with a length of 3.5 m. The tape was placed on the bottom belt. The belt speed was set to 2 m/min, a belt gap of 2.3 mm and the belt temperature was set to 190° C. On average, the thickness of tape obtained after using the double belt press was 1.7 mm.

### Method 2

Tapes were prepared from sheathed continuous multifilament strands according to the method as described in WO2016/142784A1 On average, the thickness of tape obtained was 0.5 mm.

TABLE 2
The composition of the sheathed continuous multifilament
strands produced using method 2.

| Uni-directional | Non-FR | FR |
|---|---|---|
| tape | tape | tape |
| PP1 (wt %) | 36.24 | 16.24 |
| GF (wt %) | 60.30 | 60.30 |
| Coupling | 3.00 | 3.00 |
| agent (wt %) | | |
| Impregnating | 0.00 | 0.00 |
| agent (wt %) | | |
| UV stabilizer | 0.06 | 0.06 |
| (wt %) | | |
| Thermal | 0.40 | 0.40 |
| stabilizer | | |
| (wt %) | | |
| FR (wt %) | 0.00 | 20 |

### Step 2. Preparation of the Construction Profile

The construction profile was extruded at a temperature of 170-195° C. and a line speed of 0.35 m/min. The die dimensions resulted in a product with sheet thickness 55+/−1.0 mm, top/bottom layer with wall thickness 3.2 mm and rib thickness 2.0+/−0.2 mm, width 237+/−3 mm.

Two types of construction profiles were prepared:

one containing a flame retardant and the other not containing a flame retardant.

The flame retardant (FR profile) construction profiles were prepared from a composition containing:

−50 wt % SABIC® STAMAX 60YM240, which is a 60 wt % long glass fiber concentrate commercially available from SABIC. The glass fibres are chemically coupled to the PP matrix
25 wt % SABIC® PP 83MF10, which is a heterophasic propylene copolymer having a melt flow rate of 1.8 dg/min as measured according to ISO1133 (2.16 kg, 230° C.)
25 wt % ADK STAB FP-2100 JC

The non-flame retardant (non-FR profile) construction profiles were prepared from a composition containing:
50 wt % SABIC® STAMAX 60YM240, which is a 60 wt % long glass fiber concentrate commercially available from SABIC. The glass fibres are chemically coupled to the PP matrix
50 wt % SABIC® PP 83MF10, which is a heterophasic propylene copolymer having a melt flow rate of 1.8 dg/min as measured according to ISO1133 (2.16 kg, 230° C.)

### Step 3. Application of the Tape onto the Construction Profile

The tapes prepared in step 1 according to method 1 and 2 were laminated onto the construction profile as prepared in step 2 using a double belt press machine ((KFK-XL 1900 from Mayer, RutzDouble). The belt temperature was set to 200° C., the belt gap was set to 59 mm and the belt speed was set to 2 m/min. Each construction profile had a dimension of 237 mm width and 3 m length. Two types of construction profiles were used: FR profile and non-FR profile. Table 4 below summarizes the composition of the construction profile, the method to prepare and the composition of the tape, the number of tape layers applied to the contruction profile, the tape direction and the (sum of the) thickness of the tape(s). In Ex 3, after the tapes were provided, 0.8 mm of a film made of a composition consisting of 60 wt % of polypropylene, 20 wt % of talc and 20 wt % of ADK STAB FP-2200S was provided thereon.

### Single Burning Item Test

The single burning item (SBI) test (method EN 13823:2014) is considered as a regulatory test that building/construction products should go through before being classified based on their flame retardant properties.

### Procedure

The procedure of the SBI test involves exposing the specimen to a diffusive flame of 30 kW. This flame is provided by burning propane in a diffusion gas burner. The test specimen includes two samples, each with dimensions of 1.5 m×1.0 m and 1.5 m×0.5 m. The two samples are mounted at a right angle, which creates a corner to form a specimen. The specimen is mounted on a floor and then placed on a trolley, as can be seen in the Figure below. The time of exposure to the flame is 20 minutes. A hood is used to collect the combustion gases. Smoke production is measured by attenuation of a light signal which is introduced in the exhaust duct. There are differential pressure probes, gas sample probes and thermocouples in the system for measurement purposes. At the end of the test various parameters can be determined.
Heat release rate, measured in kW
Fire growth rate (FIGRA) based on heat release, measured in W/s
Total heat release in the first 10 minutes (THR600s), measured in MJ
Total smoke production (TSP), measured in m2
Smoke growth rate (SMOGRA), measured in m2/s2
Lateral flame spread (LFS) to the end of the long wing, which is visually observed
Burning droplets and particles, which are visually observed

### Classification

Based on the test results, the test specimen can be classified into class A2, B, C and D. The criteria that determines the class of a test specimen is shown in the table below.

TABLE 3
classification according to SBI test performed according to EN 13823:2014

| | | | | Flaming droplets/ | |
|---|---|---|---|---|---|
| | | | | particles | |
| Main classification | | Smoke classification | | classification | |
| Class | Criteria | Class | Criteria | Class | Criteria |
| A1 | No contribution to fire | — | — | — | — |
| A2 | FIGRA ≤ 120 W/s | s1 | SMOGRA ≤ 30 m²/s² | d0 | No flaming |
| | LFS < edge of specimen | | TSP₆₀₀ₛ ≤ 50 m² | | droplets or |
| | THR₆₀₀ₛ ≤ 7.5 MJ | | | | particles |
| B | FIGRA ≤ 120 W/s | s1 | SMOGRA ≤ 30 m²/s² | d0 | No flaming |
| | LFS < edge of specimen | | TSP₆₀₀ₛ ≤ 50 m² | | droplets or |
| | THR₆₀₀ₛ ≤ 7.5 MJ | | | | particles |
| C | FIGRA ≤ 250 W/s | s2 | SMOGRA ≤ 180 m²/s² | d1 | No flaming |
| | LFS < edge of specimen | | TSP₆₀₀ₛ ≤ 200 m² | | droplets or |
| | THR₆₀₀ₛ ≤ 15 MJ | | | | particles |
| | | | | | persisting < |
| | | | | | 10 s |
| D | FIGRA ≤ 750 W/s | s3 | — | d2 | — |

For the experimentals as provided herein, the single burning item (SBI) test method was performed according to EN 13823:2014.

TABLE 4
Profiles provided with tapes made by Method 1

| | | CE1 | CE2 | CE3 | Ex. 1 |
|---|---|---|---|---|---|
| Profile | FR or | Non-FR | FR | FR | FR |
| | non-FR | | | | |
| tape | | — | — | Non-FR | FR |
| # layers | | 0 | 0 | 1 | 1 |
| Direction | Cross/uni | | | uni | Uni |
| of layers | | | | | |
| Layer | | | | 1.8 | 1.8 |
| thickness | | | | | |
| (mm) | | | | | |
| results | | FAIL | FAIL | FAIL | Class C |

As can be seen from the results in the above Table, the article of the invention (Ex. 1) comprising a flame retardant tape passes class C of the SBI test, whereas articles not containing flame retardant in the tape do not (CE1, CE2, CE3). In addition, it can also be seen from the Table 4, that the presence of a flame retardant tape on the construction profile is needed for passing the class C SBI test.

TABLE 5
Profiles provided with tapes made by Method 2

| | CE1 | CE2 | CE4 | CE5 | Ex. 2 | Ex. 3 |
|---|---|---|---|---|---|---|
| Profile | Non-FR | FR | Non-FR | FR | FR | FR |
| tape | | | FR | FR | FR | FR |
| # layers | 0 | 0 | 1 | 1 | 2 | 2 |
| Direction | — | — | Cross | Cross | Cross | Cross |
| of layers | | | | | | |
| Layer | — | — | 0.5 | 0.5 | 1.0 | 1.0 |
| thickness | | | | | | |
| (mm) | | | | | | |
| Cover | | | | | | Yes |
| film | | | | | | (0.8 mm) |
| results | FAIL | FAIL | FAIL | FAIL | Class D | Class C |

As can be seen from the Results, the article of the invention (Ex. 2, Ex. 3) comprising flame retardant tapes passes class D respectively class C of the SBI test, whereas articles with thinner or no tapes do not (CE1, CE2, CE4, CE5).

1. An elongate profiled object having a cross section, the object comprising a peripheral wall, forming a hollow profile extending in a longitudinal direction, wherein at least part of the peripheral wall is provided with a reinforcement layer extending in at least the longitudinal direction of the elongate profiled object,
wherein the reinforcement layer comprises a tape or a laminate of tapes, wherein the reinforcement layer has a thickness of at least 0.6 mm and
the tape is made of a first thermoplastic composition, which is a fiber reinforced thermoplastic composition comprising a flame retardant,
wherein the elongate profiled object is made of a second thermoplastic composition.

2. The elongate profiled object according to claim 1, wherein the tape in the reinforcement layer is a tape comprising a plurality of sheathed continuous multifilament strands,
wherein each of the sheathed continuous multifilament strands comprises a core that extends in the longitudinal direction and a polymer sheath which intimately surrounds said core,
wherein each of the cores comprises an impregnated continuous multifilament strand comprising at least one continuous glass multifilament strand, wherein the at least one continuous glass multifilament strand is impregnated with an impregnating agent,
wherein the polymer sheath consists of a thermoplastic polymer composition comprising the flame retardant.

3. The elongate profiled object according to claim 1, wherein the tape in the reinforcement layer is a fiber-reinforced composite comprising:
a matrix material including a thermoplastic polymer composition comprising the flame retardant; and
a non-woven fibrous region comprising a plurality of continuous fibers dispersed in the matrix material;
wherein the width and the length of the non-woven fibrous region are substantially equal to the width and the length, respectively, of the fiber-reinforced composite;
wherein the non-woven fibrous region has a mean relative fiber area coverage (RFAC) (%) of from 65 to 90 and a coefficient of variance (COV) (%) of from 3 to 20; and
wherein each of the plurality of continuous fibers is substantially aligned with the length of the fiber-reinforced composite.

4. The elongate profiled object according to claim 1, wherein the reinforcement layer is the laminate of tapes.

5. The elongate profiled object according to claim 1, wherein the reinforcement layer has a thickness of at least 0.8 mm and/or at most 5.0 mm.

6. The elongate profiled object according to claim 1, wherein the flame retardant in the first thermoplastic composition is a mixture of an organic phosphate compound, an organic phosphoric acid and a zinc oxide; wherein the weight ratio of phosphate compound to phosphoric acid compound is from 1:0.01 to 1:2 and wherein the zinc oxide is present in an amount of from 2-10 wt. % based on the weight of the flame retardant.

7. The elongate profiled object according to claim 1, wherein the second thermoplastic composition comprises a flame retardant; wherein the weight ratio of phosphate compound to phosphoric acid compound is from 1:0.01 to 1:2 and wherein the zinc oxide is present in an amount of from 2-10 wt. % based on the weight of the flame retardant.

8. The elongate profiled object according to claim 1, wherein the elongate profiled object further comprises a thermoplastic polymer film provided over the tape or the laminate of tapes.

9. The elongate profiled object according to claim 8, wherein the thermoplastic polymer film comprises a flame retardant; wherein the weight ratio of phosphate compound to phosphoric acid compound is from 1:0.01 to 1:2 and wherein the zinc oxide is present in an amount of from 2-10 wt. % based on the weight of the flame retardant.

10. The elongate profiled object according to claim 8, wherein the thermoplastic polymer film has a thickness of 0.5 to 1.5 mm.

11. The elongate profiled object according to claim 1, wherein the elongate profiled object has a flame retardancy of at least class D as determined by SBI test according to EN13823:2014.

12. The elongate profiled object according to claim 1, wherein the first thermoplastic composition and/or the second thermoplastic composition comprises a polyolefin.

13. A method for manufacturing the elongate profiled object according to claim 1, the method comprising: molding a second thermoplastic polymer composition to provide an elongate profiled object having a peripheral wall forming a hollow profile extending in a longitudinal direction; and providing a reinforcement layer at at least part of the peripheral wall.

14. A tape comprising a plurality of sheathed continuous multifilament strands,
wherein each of the sheathed continuous multifilament strands comprises a core that extends in the longitudinal direction and a polymer sheath which intimately surrounds said core,
wherein each of the cores comprises an impregnated continuous multifilament strand comprising at least one continuous glass multifilament strand, wherein the at least one continuous glass multifilament strand is impregnated with an impregnating agent,
wherein the polymer sheath consists of a thermoplastic polymer composition comprising a flame retardant.

15. A fiber-reinforced composite comprising:
a matrix material including a thermoplastic polymer composition comprising a flame retardant; and
a non-woven fibrous region comprising a plurality of continuous fibers dispersed in the matrix material;
wherein the width and the length of the non-woven fibrous region are substantially equal to the width and the length, respectively, of the fiber-reinforced composite;
wherein the non-woven fibrous region has a mean relative fiber area coverage (RFAC) (%) of from 65 to 90 and a coefficient of variance (COV) (%) of from 3 to 20; and
wherein each of the plurality of continuous fibers is substantially aligned with the length of the fiber-reinforced composite.
